(19) United States
(12) Patent Application Publication
(10) Pub. No.: US 2026/0336507 A1
(43) Pub. Date: Oct. 29, 2026

(54) Combined Structure for Splicing Bar-Shaped Working Lights of Motor Vehicles

(71) Applicant: Guangzhou Ouge Electronic Technology Co., Ltd, Guangdong (CN)

(72) Inventor: Caijun LAN, Guangdong (CN)

(73) Assignee: Guangzhou Ouge Electronic Technology Co., Ltd, Guangdong (CN)

(21) Appl. No.: 19/408,014

(22) Filed: Dec. 3, 2025

(30) Foreign Application Priority Data
Apr. 23, 2025 (CN) 2025207756920

(51) Int. Cl. B60Q 1/00; B60Q 1/26; B60Q 1/28; B60Q 1/30

(52) U.S. Cl. CPC B60Q 1/0088; B60Q 1/2615; B60Q 1/2611; B60Q 1/28; B60Q 1/30

(57) ABSTRACT

The present invention relates to the technical field of bar-shaped working lights of motor vehicles, specifically providing a combined structure for splicing bar-shaped working lights. It includes several first lamp bodies and second lamp bodies, both ends of which are equipped with splicing slots. The slot ends feature semi-conical holes, forming a trapezoidal structure with internal grooves. The splicing slots are inserted with locking assemblies installed inside. Through modular design, lamp bodies of different lengths can be spliced with locking assemblies, allowing flexible combination of bar-shaped working lights that meet various length requirements.

### CROSS-REFERENCE TO RELATED APPLICATIONS

This application claims priority to Chinese Patent Application No. 202520775692.0, titled "Combined Structure for Splicing Bar-Shaped Working Lights of Motor Vehicles," filed on Apr. 23, 2025, the content of which, including the amendments thereof, is incorporated herein by reference in its entirety.

### TECHNICAL FIELD

The present disclosure relates to the technical field of bar-shaped working lights for motor vehicles, particularly to a combined structure for splicing bar-shaped working lights of motor vehicles.

### BACKGROUND

Bar-shaped working lights for motor vehicles are lighting fixtures installed on motor vehicles to provide auxiliary illumination. They are typically elongated, with customizable lengths based on vehicle requirements, and narrow widths for easy installation at specific positions such as the roof, front, or rear of the vehicle.

The inventors of this application have identified the following issues during practical use:

Currently, most auxiliary bar-shaped working lights for motor vehicles on the market are standalone devices, with the longest exceeding 50 inches or more. Due to the excessive length of the lamp body, significant inconveniences arise in production, transportation, quality control, and after-sales service, greatly reducing production efficiency. Additionally, waterproofing requirements pose major challenges in design and production, leading to higher defect rates during mass production.

Therefore, it is necessary to provide a combined structure for splicing bar-shaped working lights of motor vehicles to address the above technical issues.

### SUMMARY

The technical problem to be solved by the present disclosure is the inconvenience caused by excessively long lamp bodies in production, transportation, quality control, and after-sales service. To address the above defects in the prior art, a combined structure for splicing bar-shaped working lights of motor vehicles is provided.

To achieve the above objective, the technical solution of the present disclosure is: a combined structure for splicing bar-shaped working lights of motor vehicles include several first lamp bodies and second lamp bodies. Both ends of the first lamp bodies and the second lamp bodies are equipped with splicing slots; one end of each splicing slot has a semi-conical hole, and the splicing slot features a trapezoidal structure with an internal groove; a locking assembly is inserted into the splicing slot, and the locking assembly comprises a front splicing bracket and a rear splicing bracket; one end of the outermost second lamp body is fixedly connected to a small decorative cover, and one side of the splicing slot is provided with a lamp-side threaded hole.

By adopting the above technical solution, the first and second lamp bodies are modular, with splicing slots at both ends, enabling free combination of lamp body lengths and solving the production and transportation challenges of traditional long lamp bodies. The splicing slots have a trapezoidal cross-section, with an internal groove and a semi-conical hole on one side to provide space for inserting and tightening screws.

Further, the lamp-side threaded hole is connected to a side mounting bracket through a fastening screw. One side of the lamp-side threaded hole is provided with a connecting threaded hole. There are two connecting threaded holes, with a cross plate positioned between them.

By adopting the above technical solution, the side mounting bracket is fixed through the lamp-side threaded hole and symmetrically installed on both sides of the lamp body, enabling quick installation through standardized threaded holes while dispersing mounting stress to accommodate different vehicle models.

Further, the front splicing bracket includes a first base plate, with one side of the first base plate fixedly connected to a T-shaped pin.

By adopting the above technical solution, the front splicing bracket includes a first base plate connected to a T-shaped pin, which is equipped with a front splicing bracket screw hole for rapid combined installation.

Further, the rear splicing bracket includes a first housing, which has an I-shaped structure, with symmetrically arranged square pins on both sides of the bottom of the first housing.

By adopting the above technical solution, the rear splicing bracket includes an I-shaped first housing with symmetrical square pins, which are equipped with rear splicing bracket screw mounting holes for rapid combined installation.

Further, the locking assembly also includes a front buckle plate and a rear buckle plate. The front buckle plate includes a second base plate, with both the upper and lower sides fixedly connected to lower locking plates, which are equipped with multiple triangular locking blocks.

By adopting the above technical solution, the front buckle plate includes a second base plate connected to lower locking plates, which are equipped with triangular locking blocks. This design covers the upper and lower spaces on the side of the lamp body, and by embedding the blocks into the locking plate slots, it forms a splicing lock, achieving a secure connection to the lamp body’s side.

Further, the rear buckle plate includes a second housing, with both the upper and lower sides fixedly connected to upper locking plates, which are equipped with multiple sets of locking plate slots.

By adopting the above technical solution, the rear buckle plate includes a second housing connected to upper locking plates, which are equipped with locking plate slots. The slots overlap with the front buckle plate vertically, allowing the aligned upper locking plates to maximize the engagement between the blocks and slots.

Further, the locking plate slots and triangular locking blocks interlock, while the lower locking plates and upper locking plates abut each other.

By adopting the above technical solution, the triangular locking blocks and locking plate slots are quickly inserted through inclined surfaces and engage through vertical triangular surfaces, forming a secure bite to achieve the locking effect.

Compared with related technologies, the combined structure for splicing bar-shaped working lights of motor vehicles provided by the present disclosure offers the following beneficial effects:

The present disclosure provides a combined structure for splicing bar-shaped working lights of motor vehicles. By arranging a first lamp body, a second lamp body, splicing slots, semi-conical holes, and a locking assembly, the auxiliary lighting bar-shaped working lights for motor vehicles are modularized. Several lamp bodies of shorter sizes and different lengths are produced, and the lamp body modules are connected through splicing installation brackets, thereby obtaining bar-shaped working lights of varying required lengths. After modularization, production and material preparation become significantly more convenient, and substantial cost savings are achieved in backend testing and after-sales services. For example, if only one lamp body module in an entire combined lighting fixture is damaged, only that damaged module needs replacement, eliminating the need to replace the entire fixture.

The present disclosure provides a combined structure for splicing bar-shaped working lights of motor vehicles. By adopting a front buckle plate and a rear buckle plate, the triangular locking block of the front buckle plate and the locking plate slot of the rear buckle plate are fixed through inclined surface interlocking, eliminating the need for front splicing bracket fixing screws and corresponding threaded holes, thereby directly reducing the use of parts such as screws and washers.

### BRIEF DESCRIPTION OF DRAWINGS

The drawings, which form part of this application, are provided to further illustrate the present disclosure. The illustrative embodiments and descriptions thereof are intended to explain the present disclosure and do not constitute undue limitations. In the drawings:

FIG. 1 is an exploded perspective structural diagram of the present disclosure;

FIG. 2 is a perspective structural diagram of the first lamp body of the present disclosure;

FIG. 3 is a perspective structural diagram of the second lamp body of the present disclosure;

FIG. 4 is a perspective structural diagram of the grooves of the first lamp body and the second lamp body of the present disclosure;

FIG. 5 is a structural diagram of the front splicing bracket of the present disclosure;

FIG. 6 is a perspective structural diagram of the small decorative cover of the present disclosure;

FIG. 7 is a perspective structural diagram of the rear splicing bracket of the present disclosure;

FIG. 8 is an assembled perspective structural diagram of the first lamp body and the second lamp body of the present disclosure;

FIG. 9 is a perspective structural diagram of the front buckle plate of the present disclosure;

FIG. 10 is a structural diagram of the rear buckle plate of the present disclosure;

FIG. 11 is a connection diagram of the power cord of the present disclosure.

Reference signs: 1, First Lamp Body; 2, Second Lamp Body; 3, Splicing Slot; 4, Semi-Conical Hole; 5, Locking Assembly; 51, Front Splicing Bracket; 511, First Base Plate; 512, T-Shaped Pin; 513, Pressing Threaded Hole; 52, Rear Splicing Bracket; 521, First Housing; 522, Square Pin; 523, Through Hole; 53, Front Buckle Plate; 531, Second Base Plate; 532, Lower Locking Plate; 533, Triangular Locking Block; 54, Rear Buckle Plate; 541, Second Housing; 542, Upper Locking Plate; 543, Locking Plate Slot; 6, Small Decorative Cover; 7, Groove; 8, Lamp-Side Threaded Hole; 9, Side Mounting Bracket; 10, First Splicing Fixing Screw Hole; 11, Cross Plate; 12, Rear Splicing Bracket Spring Washer; 13, Rear Splicing Bracket Fixing Screw; 14, Front Splicing Bracket Flat Washer; 15, Front Splicing Bracket Spring Washer; 16, Front Splicing Bracket Fixing Screw; 17, Mounting Screw; 18, Side Bracket Spring Washer; 19, Side Bracket Fixing Screw; 20, Mounting Flat Washer; 21, Mounting Spring Washer; 22, Mounting Nut; 23, Power Cord; 2-1, Second Splicing Fixing Screw Hole; 1-2, First Rear Splicing Slot; 2-2, Second Rear Splicing Slot; 11-1, Small Decorative Cover T-Shaped Pin; 11-2, Small Decorative Cover Locking Notch.

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms "comprising" and/or "including" are used in this specification, they specify the presence of features, steps, operations, equipment, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

### Embodiment 1

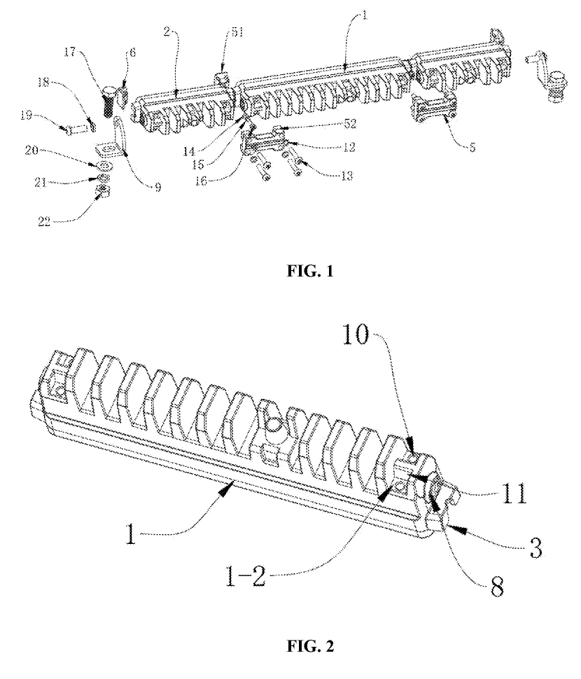

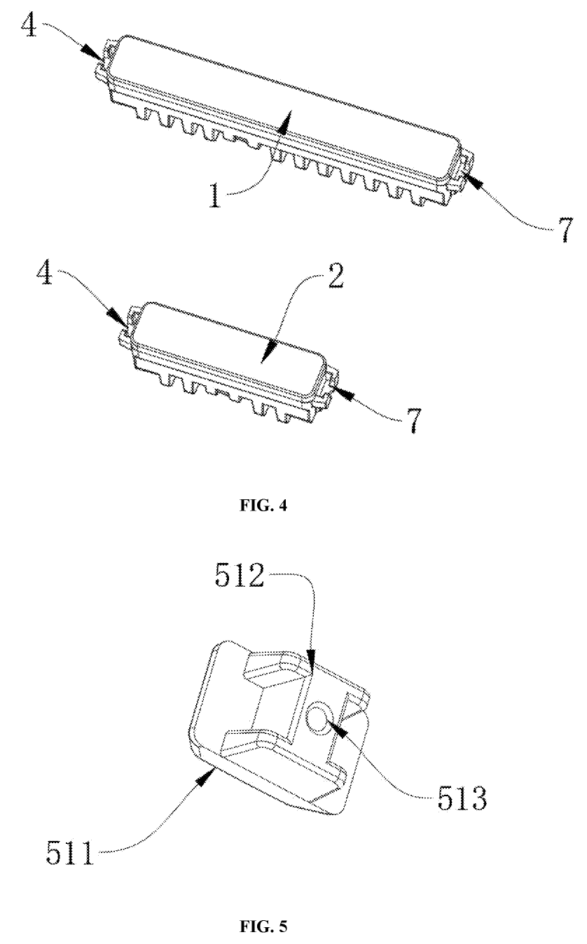

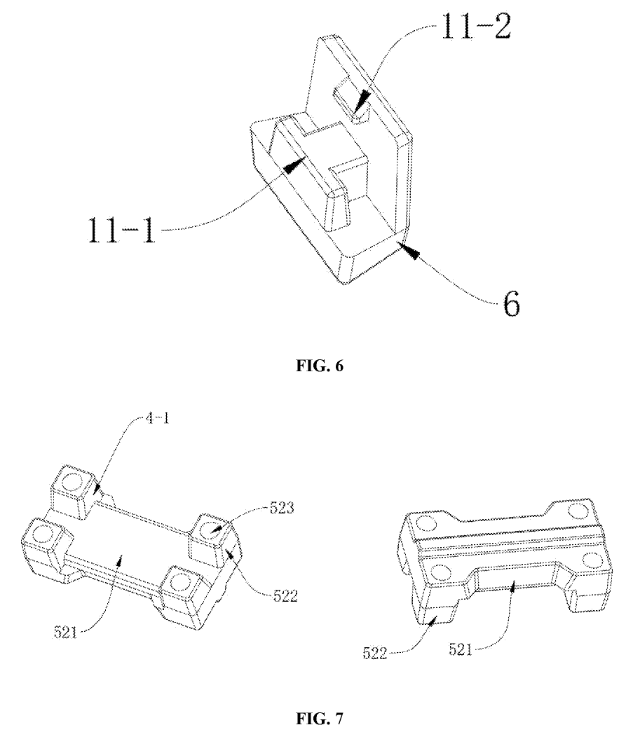

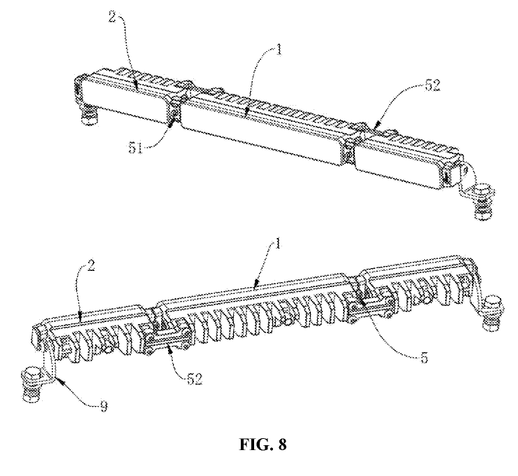

As shown in FIGS. 1-10, the combined structure for splicing bar-shaped working lights of motor vehicles according to the present disclosure includes several first lamp bodies 1 and second lamp bodies 2. Both ends of the first lamp body 1 and the second lamp body 2 are provided with splicing slots 3. One end of the splicing slot 3 is provided with a semi-conical hole 4. The splicing slot 3 has a trapezoidal structure and is internally provided with a groove 7. The splicing slot 3 is inserted with a locking assembly 5 for splicing adjacent lamp bodies. The locking assembly 5 includes a front splicing bracket 51 and a rear splicing bracket 52. One end of the outermost second lamp body 2 is detachably installed with a small decorative cover 6. One side of the splicing slot 3 is provided with a lamp-side threaded hole 8. The locking assembly 5 comprises the front splicing bracket 51 and the rear splicing bracket 52. The front and rear clamping structure enhances connection reliability. The small decorative cover 6 features a T-shaped pin and snap fit, covering the splicing slots 3 at both ends, improving appearance and protective performance.

Specifically, referring to FIG. 11, a power cord 23 is also provided on the first lamp body 1 and the second lamp body 2 near the rear splicing bracket 52 and away from the front splicing bracket 51. The power cord 23 can supply power to each lamp body. The independent power supply method ensures that the number of spliced lamp bodies is not limited by the internal circuit’s capacity. Users can flexibly increase or decrease the number of lamp bodies according to actual lighting needs, and the power system only requires corresponding parallel expansion, offering higher flexibility in product configuration.

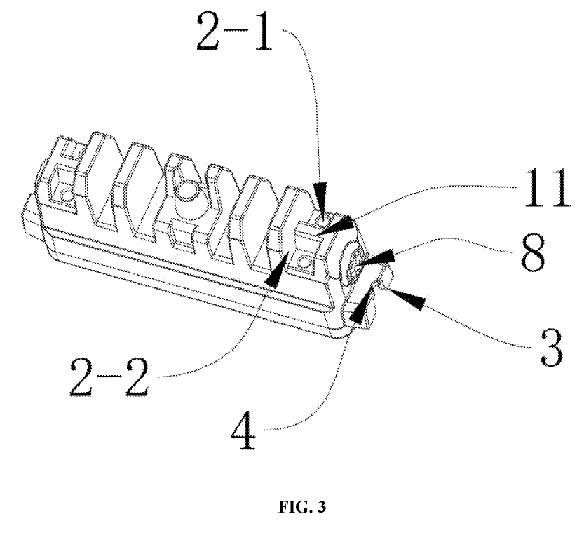

As shown in FIG. 2, the lamp-side threaded hole 8 is connected to the side mounting bracket 9 through a fastening screw. One side of the lamp-side threaded hole 8 is provided with connecting threaded holes, which are arranged in a pair. Between the two connecting threaded holes is a cross plate 11, which serves as a reinforcing rib—a trapezoidal plate separating the two connecting threaded holes. On one hand, it enhances the structural strength of the bracket and prevents deformation of the lamp body; on the other hand, it provides sufficient positioning and fixing functions.

As shown in FIGS. 3 and 5, the front splicing bracket 51 includes a first base plate 511. One side of the first base plate 511 is fixedly connected to a T-shaped pin 512, which is inserted into the splicing slot 3 at the end of the lamp body and engages with the internal groove 7. By adjusting the preload, the tightness of the connection can be regulated, while the T-shaped anti-detachment design enhances installation stability.

As shown in FIG. 7, the rear splicing bracket 52 includes a first housing 521 and a fixing assembly for securely mounting the rear splicing bracket 52 to the lamp body. The fixing assembly is preferably a rear splicing bracket fixing screw 13. The first housing 521 features an I-shaped structure, with symmetrically arranged square pins 522 on both sides of its bottom. The square pins 522 are inserted into the first rear splicing slot 1-2 and the second rear splicing slot 2-2 at the lamp body end. Dual reinforcement is achieved through self-locking by inclined surfaces and screw fixation, while the I-shaped structure evenly distributes forces, effectively preventing unilateral deformation.

Implementation: First, it consists of the first lamp body 1, second lamp body 2, front splicing bracket 51, rear splicing bracket 52, rear splicing bracket spring washer 12, rear splicing bracket fixing screw 13, front splicing bracket flat washer 14, front splicing bracket spring washer 15, front splicing bracket fixing screw 16, side mounting bracket 9, small decorative cover 6, mounting screw 17, side bracket spring washer 18, side bracket fixing screw 19, mounting flat washer 20, mounting spring washer 21, and mounting nut 22. The first lamp body 1 is equipped with: a connecting threaded hole, first rear splicing slot 1-b, lamp-side threaded hole 8, and groove 7, where the connecting threaded hole is preferably the first splicing fixing screw hole 10. The second lamp body 2 is equipped with: a connecting threaded hole, second rear splicing slot 2-2, lamp-side threaded hole 8, and groove 7, where the connecting threaded hole is preferably the second splicing fixing screw hole 2-1. The front splicing bracket 51 is equipped with: a front splicing bracket T-shaped pin 512 and front splicing bracket screw hole 513. The rear splicing bracket 52 is equipped with: a rear splicing bracket square pin 522 and rear splicing bracket screw mounting hole 523. The small decorative cover 6 is equipped with: a small decorative cover T-shaped pin 11-1 and small decorative cover locking notch 11-2.

Specifically, the splicing principle of the locking assembly 5 is as follows: The front splicing bracket 51 is inserted from the lamp body end face through its T-shaped pin 512 and snapped into the groove 7 of the splicing slot 3 to achieve front-end positioning. The rear splicing bracket 52 is inserted from the back of the lamp body through its square pin 522 into the first rear splicing slot 1-2 and second rear splicing slot 2-2, and tightened with the rear splicing bracket fixing screw 13. The tightening force of the rear splicing bracket fixing screw 13 drives the inclined surface of the rear splicing bracket 52 and the inclined surface of the rear splicing slot to wedge tightly together, thus firmly clamping the side-by-side first lamp body 1, second lamp body 2, front splicing bracket 51, and rear splicing bracket 52 into a single unit.

The first lamp body 1 and the second lamp body 2 are respectively provided with a first splicing fixing screw hole 10, a second splicing fixing screw hole 2-1, a first rear splicing slot 1-2, a second rear splicing slot 2-2, and a splicing slot 3. The front splicing bracket 51 is equipped with a T-shaped pin 512 and a screw hole 513. After the first lamp body 1 and the second lamp body 2 are aligned side by side, the T-shaped pin 512 of the front splicing bracket 51 is aligned with the splicing slots 3 of both lamp bodies, and the front splicing bracket fixing screw 16 is tightened onto the two lamp bodies. Between the fixing screw and the lamp body, a front splicing bracket flat washer 14 and a front splicing bracket spring washer 15 are placed to prevent loosening. From the rear of the lamp body, the square pin 522 of the rear splicing bracket 52 is inserted into the first rear splicing slot 1-2 and the second rear splicing slot 2-2 of the two lamp bodies. Then, the rear splicing bracket fixing screw 13 is passed through the rear splicing bracket screw mounting hole 523 and tightened into the first splicing fixing screw hole 10 and the second splicing fixing screw hole 2-1. When tightening the screw, a clamping force is applied to the rear splicing bracket 52 toward the lamp body. Since the square pin 522 on the rear splicing bracket 52 and the first rear splicing slot 1-2 and second rear splicing slot 2-2 on the lamp body have the same inclined surfaces, the first lamp body 1 and the second lamp body 2 are tightly clamped together with the rear splicing bracket 52 as a single unit, forming a spliced linear lamp body. Between the rear splicing bracket 52 and the rear splicing bracket fixing screw 13, a rear splicing bracket spring washer 12 is placed, which serves to prevent loosening in the connection structure. With the front splicing bracket 51 at the front and the rear splicing bracket 52 at the rear securing the first lamp body 1 and the second lamp body 2, the overall connection structure becomes more robust and reliable. The splicing slots 3 at both ends of the spliced lamp body are each fitted with a small decorative cover 6. The small decorative cover 6 is made of plastic and features a small decorative cover T-shaped pin 11-1 and a small decorative cover locking notch 11-2. During assembly, the T-shaped pin 11-1 is inserted into the groove 7 of the lamp body, and once fully inserted, the small decorative cover locking notch 11-2 snaps tightly onto the lamp body.

On both end sides of the first lamp body 1 and the second lamp body 2, lamp-side threaded holes 8 are provided. The side mounting bracket 9 is fastened to both sides of the lamp body through the side bracket fixing screw 19. Between the side mounting bracket 9 and the side bracket fixing screw 19, a side bracket spring washer 18 is installed to secure and prevent loosening. The mounting screw 17 is the fixing screw used to attach the combined strip lamp to the motor vehicle. The motor vehicle has a fixing hole, and the mounting screw 17 passes through the hole at the bottom of the side mounting bracket 9, then through the fixing hole on the motor vehicle, the mounting flat washer 20, and the mounting spring washer 21. Finally, it is threaded and tightened at the bottom with the mounting nut 22, securing the combined lamp body for use on the motor vehicle.

### Embodiment 2

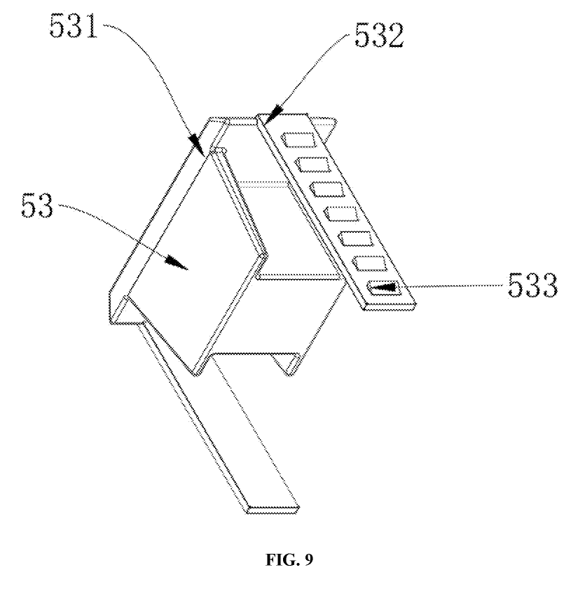

As shown in FIG. 9, based on Embodiment 1, the present disclosure provides a technical solution: The locking assembly 5 further includes a front buckle plate 53 and a rear buckle plate 54. The front buckle plate 53 comprises a second base plate 531, with lower locking plates 532 fixed on both the upper and lower sides of the second base plate 531. The lower locking plates 532 are provided with multiple triangular locking blocks 533, replacing screw fixation with quick snap-on connections to reduce part count and improve installation efficiency.

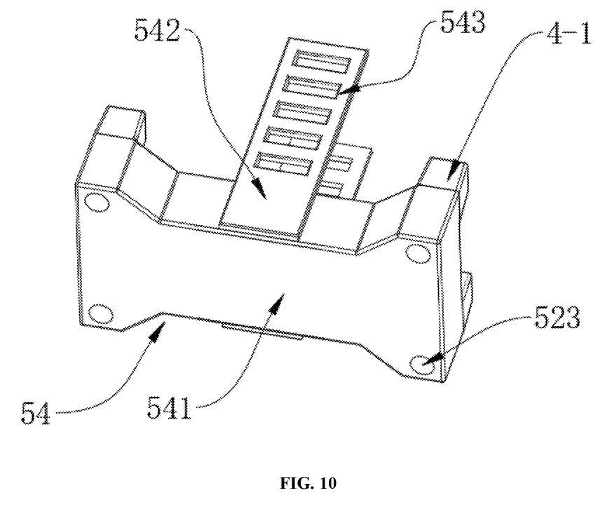

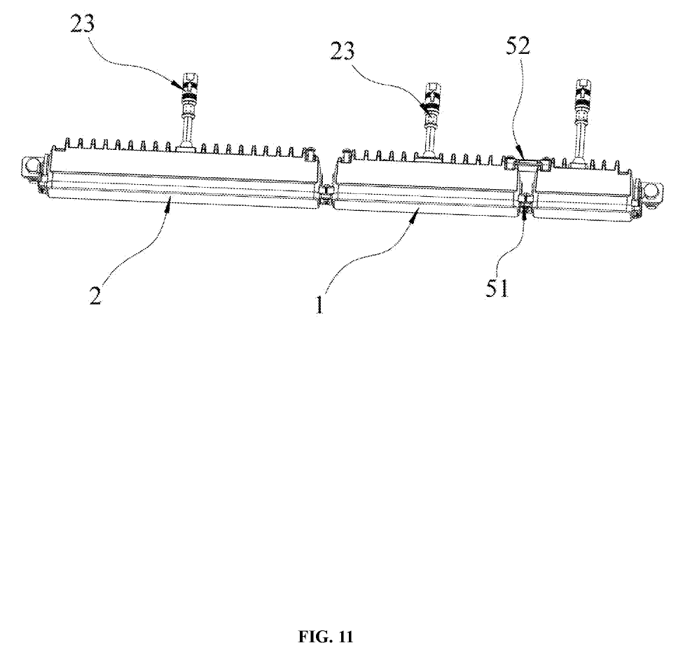

As shown in FIG. 10, the rear buckle plate 54 comprises a second housing 541, with upper locking plates 542 fixed on both the upper and lower sides of the second housing 541. The upper locking plates 542 are equipped with multiple sets of locking plate slots 543, which interlock by engaging with the triangular locking blocks 533. The anti-retraction design of the locking plate slots 543 gripping the triangular locking blocks 533 ensures a secure connection.

As shown in FIGS. 9 and 10, the locking plate slots 543 and triangular locking blocks 533 snap together, while the lower locking plates 532 and upper locking plates 542 press against each other, transmitting locking force and preventing loosening. The interlocking provides vibration resistance, making it suitable for vehicular environments.

During implementation, after docking the first lamp body 1 and the second lamp body 2, the front splicing bracket screw hole 513 can be omitted. During installation, first buckle the front buckle plate 53 onto one side of the first lamp body 1 and the second lamp body 2. Then insert the square pin 522 of the rear splicing bracket 52 into the first rear splicing slot 1-2 and the second rear splicing slot 2-2 on the back of the lamp body. Next, directly slot the rear buckle plate 54 onto the front buckle plate 53, where the triangular locking block 533 and the locking plate slot 543 interlock, thereby pressing and securing the first lamp body 1 and the second lamp body 2. Finally, use the rear splicing bracket fixing screw 13 to fasten the rear splicing bracket 52 to the lamp body. This eliminates the need for one front splicing bracket fixing screw 16 and the front splicing bracket screw hole 513, improving yield and reducing costs.

The advantages of this technical solution in practical applications include, but are not limited to, the following:
1. Modularization greatly facilitates production and material preparation, while also significantly reducing costs for backend testing and after-sales service.
2. The triangular locking block 533 of the front buckle plate 53 and the locking plate slot 543 of the rear buckle plate 54 are secured through inclined plane interlocking, eliminating the need for the front splicing bracket fixing screw 16 and its corresponding threaded hole.

### Embodiment 3

In another embodiment of the present disclosure (not shown), to achieve faster disassembly and maintenance while ensuring connection reliability, the screw-locking structure formed by the front splicing bracket 51 and the rear splicing bracket 52 in the present disclosure can be replaced with an eccentric cam quick-lock mechanism.

Specifically, the front splicing bracket 51 is modified to include one or more rotatable eccentric cams. During installation, first insert the T-shaped pin 512 of the front splicing bracket 51 into the splicing slot 3 of the lamp body. Then insert the square pin 522 of the rear splicing bracket 52 into the back of the lamp body. At this point, by rotating the eccentric cam on the front splicing bracket with a special-purpose tool or manually, the cam surface of the eccentric cam will push the rear splicing bracket 52 toward the lamp body as it rotates, using the inclined plane self-locking principle to tightly pull the two lamp bodies and the front and rear brackets into a single unit. For disassembly, simply rotate the eccentric cam in the opposite direction by a certain angle to release the locking force, enabling quick separation. This mechanism replaces screw tightening with a simple rotation, making operation more convenient and ensuring high repeat positioning accuracy.

### Embodiment 4

In yet another embodiment of the present disclosure (not shown), to further simplify components and reduce assembly complexity, the precise snap-fit connection between the front buckle plate 53 and the rear buckle plate 54 through the triangular locking block 533 and the locking plate slot 543 in the present disclosure can also be replaced with a bilateral elastic ratchet strap lock.

Specifically, a flexible ratchet strap made of high-strength engineering plastic or composite material is used, with male and female buckles at both ends. During installation, the strap is wrapped around the two lamp bodies to be joined. After inserting the male buckle into the female buckle, the ratchet strap is tightened to firmly secure the lamp assembly. The lock features a one-way ratchet mechanism to prevent loosening during tightening and includes a press-type release button to disengage the lock. This design integrates multiple parts into one, achieving true "one-click locking" and "one-click release," making it particularly suitable for use in space-constrained or hands-on field environments.

### Embodiment 5

In yet another embodiment of the present disclosure (not shown), to accommodate uneven mounting surfaces or enable fine adjustments, the fixed side mounting bracket 9 in the present disclosure can also be replaced with an adjustable bracket featuring a hinge and elongated holes.

Specifically, the side mounting bracket 9 is designed in two parts: one part is connected to the lamp body through screws, and the other part is fixed to the vehicle body. The two parts are linked by a hinge shaft with a locking nut. The bracket on the vehicle body side has elongated holes. During installation, the locking nut on the hinge shaft is loosened, allowing the lamp body to rotate at a certain angle around the hinge while the fixing screws can slide within the elongated holes, enabling two-dimensional adjustment of the installation angle and position. Once the optimal position is achieved, tightening the single locking nut on the hinge shaft simultaneously secures both the angle and position, greatly simplifying the adjustment process.

Although embodiments of the present disclosure have been shown and described, it should be understood by those of ordinary skill in the art that various changes, modifications, substitutions, and variations can be made to these embodiments without departing from the principles and spirit of the present disclosure. The scope of the present disclosure is defined by the appended claims and their equivalents.

In the description of the present disclosure, it should be appreciated that directional terms such as "front, rear, up, down, left, right", "horizontal, vertical, perpendicular, horizontal" and "top, bottom" etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms "inside, outside" refer to the inside and outside relative to the contour of each component itself.

For the convenience of description, spatial relative terms such as "on...", "above...", "on the upper surface of...", "upper" etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as "above other devices or structures" or "on other devices or structures" will subsequently be positioned as "below other devices or structures" or "under other devices or structures". Thus, the exemplary term "above" can include both "above" and "below" orientations. The device can also be positioned in other different ways (rotated 90 degrees or in other orientations), and the spatial relative descriptions used here should be interpreted accordingly.

In addition, it should be noted that the use of terms such as "first", "second" etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. A combined structure for splicing bar-shaped working lights of motor vehicles, comprising:
several first lamp bodies and second lamp bodies, wherein both ends of the first lamp bodies and the second lamp bodies are equipped with splicing slots;
one end of each splicing slot has a semi-conical hole, and the splicing slot features a trapezoidal structure with an internal groove;
a locking assembly is inserted into the splicing slot, and the locking assembly comprises a front splicing bracket and a rear splicing bracket;
one end of the outermost second lamp body is fixedly connected to a small decorative cover, and one side of the splicing slot is provided with a lamp-side threaded hole.

2. The combined structure for splicing bar-shaped working lights of motor vehicles according to claim 1, wherein the lamp-side threaded hole is connected to a side mounting bracket through a fastening screw;
one side of the lamp-side threaded hole is provided with two connecting threaded holes, with a cross plate placed between the two connecting threaded holes.

3. The combined structure for splicing bar-shaped working lights of motor vehicles according to claim 1, wherein the front splicing bracket comprises a first base plate, one side of the first base plate is fixedly connected to a T-shaped pin, and the T-shaped pin is provided with a pressing threaded hole.

4. The combined structure for splicing bar-shaped working lights of motor vehicles according to claim 3, wherein the rear splicing bracket comprises a first housing having an I-shaped structure, and both sides of a bottom of the first housing are equipped with symmetrically structured square pins, each provided with a through hole.

5. The combined structure for splicing bar-shaped working lights of motor vehicles according to claim 1, wherein the locking assembly further comprises a front buckle plate and a rear buckle plate;
the front buckle plate comprises a second base plate, upper and lower sides of the second base plate are fixedly connected to lower locking plates, and each lower locking plate is provided with several triangular locking blocks.

6. The combined structure for splicing bar-shaped working lights of motor vehicles according to claim 5, wherein the rear buckle plate comprises a second housing, upper and lower sides of the second housing are fixedly connected to upper locking plates, and each upper locking plate is provided with multiple sets of locking plate slots.

7. The combined structure for splicing bar-shaped working lights of motor vehicles according to claim 6, wherein the locking plate slots and the triangular locking blocks are engaged, and the lower locking plates and upper locking plates are in contact with each other.

8. The combined structure for splicing bar-shaped working lights of motor vehicles according to claim 3, wherein the T-shaped pin is configured to be inserted into the splicing slots at ends of the first lamp body and the second lamp body and locked into the grooves inside, to achieve front-end positioning and anti-detachment of the front splicing bracket at the ends of the lamp bodies.

9. The combined structure for splicing bar-shaped working lights of motor vehicles according to claim 4, wherein a back end of the first lamp body is provided with a first rear splicing slot, and a back end of the second lamp body is provided with a second rear splicing slot; and
the square pin is inserted into the rear splicing slot at a rear end of two adjacent lamp bodies.

10. The combined structure for splicing bar-shaped working lights of motor vehicles according to claim 4, wherein the rear splicing bracket comprises a rear splicing bracket fixing screw.

11. The combined structure for splicing bar-shaped working lights of motor vehicles according to claim 10, wherein the rear splicing bracket is fixedly connected to two adjacent lamp bodies by the rear splicing bracket fixing screw passing through the through hole.

12. The combined structure for splicing bar-shaped working lights of motor vehicles according to claim 7, wherein the front buckle plate and the rear buckle plate are interlocked by the engagement of the triangular locking blocks and locking plate slots.

13. The combined structure for splicing bar-shaped working lights of motor vehicles according to claim 12, wherein after interlocking, the front buckle plate and the rear buckle plate tightly press and fix two adjacent lamp bodies.

14. The combined structure for splicing bar-shaped working lights of motor vehicles according to claim 1, wherein the small decorative cover comprises a small decorative cover T-shaped pin and a small decorative cover locking notch.

15. The combined structure for splicing bar-shaped working lights of motor vehicles according to claim 14, wherein the small decorative cover is locked into the groove at an end away from a splicing area of the first and second lamp bodies by the small decorative cover T-shaped pin thereon and tightly fastened to the second lamp body by the small decorative cover locking notch.

16. The combined structure for splicing bar-shaped working lights of motor vehicles according to claim 1, wherein the first lamp body is equipped with a power cord.
